(19) United States
(12) Patent Application Publication
(10) Pub. No.: US 2013/0213188 A1
(43) Pub. Date: Aug. 22, 2013

(54) DOUBLE-SHAFT VARIABLE PROPELLER PITCH ELECTRIC BOLT-TIGHTENING MACHINE

(71) Applicants: Zhaojun Qi, Dalian (CN); Yuejin Huang, Dalian (CN)

(72) Inventors: Zhaojun Qi, Dalian (CN); Yuejin Huang, Dalian (CN)

(73) Assignee: DALIAN DEXIN M & E TECHNOLOGY ENGINEERING CO., LTD., Dalian, Liaoning (CN)

(21) Appl. No.: 13/880,983

(22) PCT Filed: Dec. 3, 2010
(86) PCT No.: PCT/CN2010/001959

§ 371 Date: Apr. 23, 2013

(30) Foreign Application Priority Data
Oct. 25, 2010 (CN) 201010517372.3

(51) Int. Cl. B23P 19/06

(52) U.S. Cl. CPC B23P 19/06
USPC 81/57.38

(57) ABSTRACT

A double-shaft variable propeller pitch electric bolt-tightening machine, comprising: a base body front end (1), a base body rear end (2), a servomotor (3), a servo rotating table (4), a servo feeding table (5), a pneumatic device (6), a main machine base (7), a lifter (8), a lift adjusting guide rod (9), a plurality of supporting rods (10), a lift platform (11), an angle adjusting meter (12), a bearing platform (13), a rotary servomotor (14), an output rotating shaft (15), a centring device (16), a rotating arm (17), a sliding lead screw (18), a tightening servomotor (19), and an automatic nut-identification and reaction force device (20). The present invention has the advantages of simple operation, high tightening precision, uniform pressing force, time-and-labor saving, low noise and no vibration. The present invention can tighten diagonal bolts on a variable propeller pitch device simultaneously and ensure the mounting precision of the variable propeller pitch device without deforming.

### TECHNICAL FIELD

The present invention relates to a field of electric bolt-tightening machine, particularly to a double-shaft variable propeller pitch electric bolt-tightening machine.

### BACKGROUND

Along with continuous development of industries, the energy problem has become more and more serious, therefore, people become focused on renewable energy sources. The wind energy is a kind of green and renewable energy, correspondingly, people become focused on wind power generation, to which a wind power variable propeller pitch device is a necessary equipment. At present, all the wind power variable propeller pitch device manufacturers adopt tools, such as pneumatic impact wrench and hydraulic wrench, to tighten and assemble bolts of the variable propeller pitch device. However, there are disadvantages including big noise and vibration, uneven torque, uncertainty of the tightening precision, easy local deformation of the variable propeller pitch device and a waste of human cost.

### SUMMARY OF THE INVENTION

To overcome the defects of the existing products, the present invention provides a double-shaft variable propeller pitch electric bolt-tightening machine.

In order to realize the above purpose, the technical solution of the present invention is as follows:

A double-shaft variable propeller pitch electric bolt-tightening machine, comprising a base body front end, a base body rear end, a servomotor, a servo rotating table, a servo feeding table, a pneumatic device, a main machine base, a lifter, a lift adjusting guide rod, supporting rods, a lift platform, an angle adjusting meter, a bearing platform, a rotary servomotor, an output rotating shaft, a centring device, a rotating arm, a sliding lead screw, a tightening servomotor, and an automatic nut-identification and reaction force device; wherein the servomotor and the servo rotating table are disposed at the base body front end, and the servo feeding table is disposed at the base body rear end; the pneumatic device is disposed at a distal end of the servo feeding table on which the main machine base is fixed; the lifter is disposed on the main machine base, and the lift adjusting guide rod is fixed on the lifter and is positioned at an upper portion of a top surface of the main machine base; the supporting rods are disposed at the top surface of the main machine base, and the lift platform is fixed on the lift adjusting guide rod and the supporting rods; the angle adjusting meter and the bearing platform are disposed on the lift platform; the rotary servomotor is disposed on the bearing platform and is connected with the output rotating shaft; the centring device and the rotating arm are disposed on the output rotating shaft; the rotating arm is provided with the sliding leads crew on which the tightening servomotor is disposed; the tightening servomotor is connected with the automatic nut-identification and reaction force device.

The automatic nut-identification and reaction force device includes a feeding lead screw, a tightening shaft, a reaction force supporting board, a dedicated sleeve and a reaction force sleeve; the reaction force supporting board is connected with the tightening shaft, and the dedicated sleeve and the reaction force sleeve are disposed on the reaction force supporting board.

The servomotor controls the servo rotating table to carry out circular motion, and precisely position three working surfaces such that a 120-degree angle is formed to each other.

The main machine base slides back and forth and is positioned on the servo feeding table.

The lift adjusting guide rod includes two lift adjusting guide rods that are in parallel with each other and vertical to the top surface of the main machine base.

The supporting rods are composed of four rods.

The position of the lift platform is capable of being adjusted by adjusting the height of the lift adjusting guide rod.

The angle adjusting meter is capable of adjusting an inclined angle of the tightening machine main body in the vertical surface.

The rotating arm is centrosymmetric with respect to the output rotating shaft.

The advantages and beneficial effects of the present invention are as follows: simple operation, high tightening precision, uniform pressing force, capability of memorizing positions of unqualified products, simultaneous tightening with respect to diagonal bolts on the variable propeller pitch device, time-and-labor saving, assurance of the mounting precision of the variable propeller pitch device without deforming.

### BRIEF DESCRIPTION OF THE DRAWINGS

FIG. 1 is a structural schematic diagram of the present invention;

FIG. 2 is a structural schematic diagram of the automatic nut-identification and reaction force device.

### DETAILED DESCRIPTION OF THE PREFERRED EMBODIMENTS

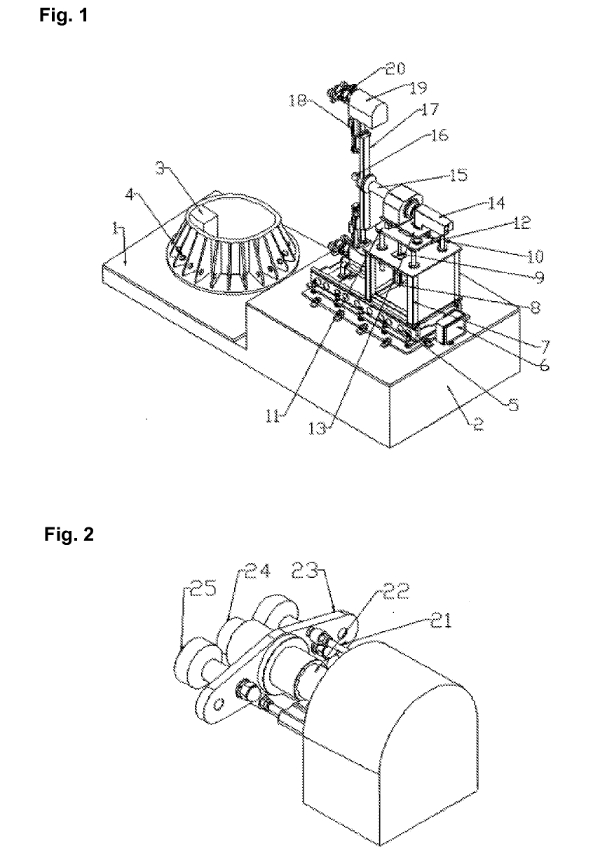

The reference numbers in FIGS. 1 and 2 are as follows: base body front end 1; base body rear end 2; servomotor 3; servo rotating table 4; servo feeding table 5; pneumatic device 6; main machine base 7; lifter 8; lift adjusting guide rod 9; supporting rods 10; lift platform 11; angle adjusting meter 12; bearing platform 13; rotary servomotor 14; output rotating shaft 15; centring device 16; rotating arm 17; sliding lead screw 18; tightening servomotor 19; automatic nut-identification and reaction force device 20; feeding lead screw 21; tightening shaft 22; reaction force supporting board 23; dedicated sleeve 24; and reaction force sleeve 25.

As shown in FIGS. 1 and 2, the double-shaft variable propeller pitch electric bolt-tightening machine mainly comprises: a base body front end 1, a base body rear end 2, a servomotor 3, a servo rotating table 4, a servo feeding table 5, a pneumatic device 6, a main machine base 7, a lifter 8, a lift adjusting guide rod 9, supporting rods 10, a lift platform 11, an angle adjusting meter 12, a bearing platform 13, a rotary servomotor 14, an output rotating shaft 15, a centring device 16, a rotating arm 17, a sliding lead screw 18, a tightening servomotor 19, and an automatic nut-identification and reaction force device 20; wherein the servomotor 3 and the servo rotating table 4 are disposed at the base body front end 1, and the servo feeding table 5 is disposed at the base body rear end 2; the pneumatic device 6 is disposed at a distal end of the servo feeding table 5 on which the main machine base 7 is fixed; the lifter 8 is disposed on the main machine base 7, and the lift adjusting guide rod 9 is fixed on the lifter 8 and is positioned at an upper portion of a top surface of the main machine base 7; the supporting rods 10 are disposed on the top surface of the main machine base 7, and the lift platform 11 is fixed on the lift adjusting guide rod 9 and the supporting rods 10; the angle adjusting meter 12 and the bearing platform 13 are disposed on the lift platform 11; the rotary servomotor 14 is disposed on the bearing platform 13 and is connected with the output rotating shaft 15; the centring device 16 and the rotating arm 17 are disposed on the output rotating shaft 15; the rotating arm 17 is provided with the sliding lead screw 18 on which the tightening servomotor 19 is disposed; the tightening servomotor 19 is connected with the automatic nut-identification and reaction force device 20; the automatic nut-identification and reaction force device 20 includes a feeding lead screw 21, a tightening shaft 22, a reaction force supporting board 23, a dedicated sleeve 24 and a reaction force sleeve 25; the reaction force supporting board 23 is connected with the tightening shaft 22, and the dedicated sleeve 24 and the reaction force sleeve 25 are disposed on the reaction force supporting board 23.

### The Working Principle of the Present Invention is as Follows:

the variable propeller pitch device to be assembled is fixed on the servo rotating table 4, and an operating button on a control panel is pressed so as to adjust a bolt mounting surface of the variable propeller pitch device to a direction facing to the tightening machine. Further, a button of the lifter 8 on the control panel is pressed to adjust the height of the lift platform 11, so as to meet the requirement of assembling height; at this time, the lifter platform 11 is precisely positioned with the bolt mounting surface of the variable propeller pitch device by the centring device 16 on the output rotating shaft 15. Moreover, the position of the feeding lead screw 21 relative to the rotating arm 17 is adjusted according to the diameter of a pitch circle on which the bolts on the variable propeller pitch device exist; pushed by the pneumatic device 6, the feeding table 5 drives the main machine base 7 to move forward; the automatic nut-identification and reaction force device 20 is sleeved on the bolt of the variable propeller pitch device, after a startup button being pressed, the two automatic nut-identification and reaction force devices 20 aligns to the diagonal bolts on the variable propeller pitch device and carries out the first tightening process. When a predetermined torque value is reached, the rotating arm 17 drives the automatic nut-identification and reaction force devices 20 to rotate circumferentially to the diagonal bolt at a next station and carries out tightening process, and at the same time, the automatic nut-identification and reaction force devices 20 memorize the positions of the unqualified products and feed the information back to a computer. When all the bolts on one bolt mounting surface of the variable propeller pitch device have been tightened, the tightening machine stops tightening process, the main machine base 7 is driven by the pneumatic device 6 to move backward, and the servo rotating table 4 drives the variable propeller pitch device to rotate 120 degree to a next working surface and repeat the above operation.

1. A double-shaft variable propeller pitch electric bolt-tightening machine, comprising: a base body front end, a base body rear end, a servomotor, a servo rotating table, a servo feeding table, a pneumatic device, a main machine base, a lifter, a lift adjusting guide rod, supporting rods, a lift platform, an angle adjusting meter, a bearing platform, a rotary servomotor, an output rotating shaft, a centring device, a rotating arm, a sliding lead screw, a tightening servomotor, and an automatic nut-identification and reaction force device; wherein,
the servomotor and the servo rotating table are disposed at the base body front end, and the servo feeding table is disposed at the base body rear end; the pneumatic device is disposed at a distal end of the servo feeding table on which the main machine base is fixed; the lifter is disposed on the main machine base, and the lift adjusting guide rod is fixed on the lifter and is positioned at an upper portion of a top surface of the main machine base; the supporting rods are disposed at the top surface of the main machine base, and the lift platform is fixed on the lift adjusting guide rod and the supporting rods; the angle adjusting meter and the bearing platform are disposed on the lift platform; the rotary servomotor is disposed on the bearing platform and is connected with the output rotating shaft; the centring device and the rotating arm are disposed on the output rotating shaft; the rotating arm is provided with the sliding lead screw on which the tightening servomotor is disposed; the tightening servomotor is connected with the automatic nut-identification and reaction force device.

2. The double-shaft variable propeller pitch electric bolt-tightening machine according to claim 1, wherein the automatic nut-identification and reaction force device includes a feeding lead screw, a tightening shaft, a reaction force supporting board, a dedicated sleeve and a reaction force sleeve; the reaction force supporting board is connected with the tightening shaft, and the dedicated sleeve and the reaction force sleeve are disposed on the reaction force supporting board.

3. The double-shaft variable propeller pitch electric bolt-tightening machine according to claim 1, wherein the servomotor controls the servo rotating table to carry out circular motion, and precisely positions three working surfaces such that a 120-degree angle is formed to each other.

4. The double-shaft variable propeller pitch electric bolt-tightening machine according to claim 1, wherein the main machine base slides back and forth and is positioned on the servo feeding table.

5. The double-shaft variable propeller pitch electric bolt-tightening machine according to claim 1, wherein the lift adjusting guide rod includes two lift adjusting guide rods that are in parallel with each other and vertical to the top surface of the main machine base.

6. The double-shaft variable propeller pitch electric bolt-tightening machine according to claim 1, wherein the supporting rods are composed of four rods.

7. The double-shaft variable propeller pitch electric bolt-tightening machine according to claim 1, wherein a position of the lift platform is capable of being adjusted by adjusting the height of the lift adjusting guide rod.

8. The double-shaft variable propeller pitch electric bolt-tightening machine according to claim 1, wherein the angle adjusting meter is capable of adjusting an inclined angle of the tightening machine main body in a vertical surface.

9. The double-shaft variable propeller pitch electric bolt-tightening machine according to claim 1, wherein the rotating arm is centrosymmetric with respect to the output rotating shaft.
